(19) United States
(12) Patent Application Publication
(10) Pub. No.: US 2008/0172470 A1
(43) Pub. Date: Jul. 17, 2008

(54) METHOD AND A SYSTEM FOR THE SECURE EXCHANGE OF AN E-MAIL MESSAGE

(75) Inventor: JORG HORN, Meerbusch (DE)

Correspondence Address: Ursula B. Day;Henry M. Feiereisen, LLC, Suite 4714, 350 Fifth Avenue, New York, NY, 10118, US

(73) Assignee: Utimaco Safeware AG, Oberursel (DE)

(21) Appl. No.: 12/013,667

(22) Filed: Jan. 14, 2008

(30) Foreign Application Priority Data
Jan. 12, 2007 (DE) 10 2007 001 883.7

(51) Int. Cl. G06F 15/16

(52) U.S. Cl. 709/206

(57) ABSTRACT

In a method and system for the secure exchange of an e-mail message, the e-mail message is initially encoded and subsequently transmitted to a recipient, wherein the e-mail message is initially encoded by means of an encoding component of the system and subsequently transmitted by means of the system thereby facilitating the secure exchange of an e-mail message without previous technical synchronization between the sender and the recipient in that the e-mail message is converted into an encoded document and the document transmitted to the recipient as an e-mail attachment, and said encoded document sent by the system as an e-mail attachment.

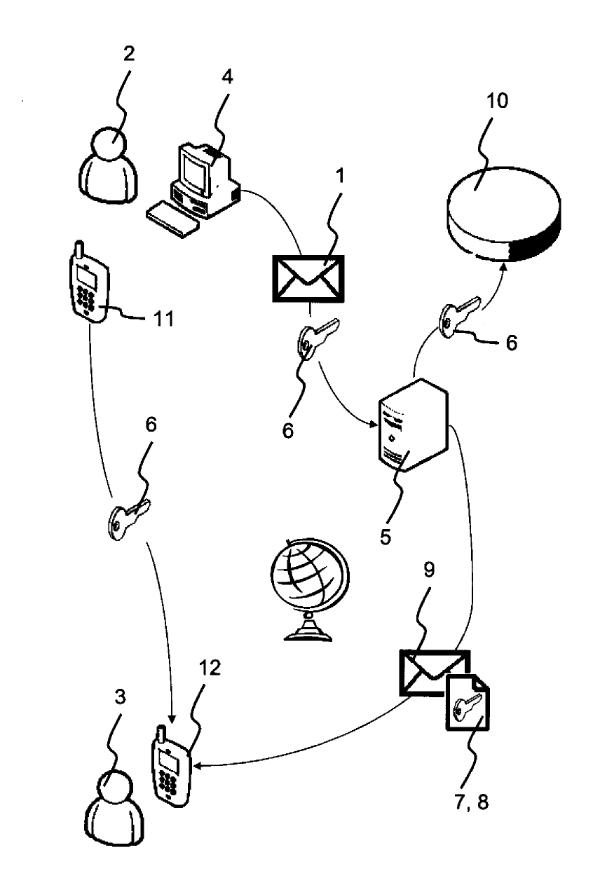

### CROSS-REFERENCES TO RELATED APPLICATIONS

This application claims the priority of German Patent Application Serial No. 10 2007 001 883.7, filed Jan. 12, 2007 pursuant to 35 U.S.C. 119(a)-(d), the subject matter of which is incorporated herein by reference.

### BACKGROUND OF THE INVENTION

The present invention relates to a method for a secure exchange of an e-mail message, wherein the e-mail message is initially encoded and subsequently transmitted to a recipient, and in particular, the invention relates to a system for a secure exchange of an e-mail message, wherein the e-mail message can be initially encoded by means of an encoding component of the system, and is subsequently transmitted by means of the system.

Such methods and systems are realized in particular in generally known servers and server applications, so-called mail servers, or also mail gateways. By means of such mail servers, e-mail messages, messages in “internet message format”, also called “E-mails” or “eMails”, according to RFC 2822 of the IETF (www.ietf.org), are managed, received, transmitted, stored, or forwarded for a larger number of users, e.g. in an intra company network.

The known mail servers comprise various components for this purpose, e.g. in the form of so-called services. A delivery component receives as a “MTA”, mail transfer agent, e-mail messages from an e-mail program of a sender in the company network, an encoding component encodes the e-mail message before transmitting it to a receiver, a receiver component stores incoming e-mail messages, in particular from outside, as a “MDA”, mail delivery agent, in the various e-mail boxes of the user of the company network, and allows as an “MRA”, mail retriever agent, the loading of the stored e-mail messages into the e-mail programs of the users.

Encoding of an e-mail message in the present context also means cryptographic encoding, like signing e-mail messages, combinations of encoding and signing, or providing an e-mail message with document specific rights of other nature.

During signing, the data to be encoded is hashed. The hash is cryptographically signed and the result is transposed into the format, onto which the cryptographic protocol is based. For S/MIME various possibilities for signing are known, wherein the data either remain legible, and the signature forms a separate block (clear signing), or the data are written into a block together with the signature (opaque signing).

During cryptographic encryption, the data themselves, not a hash of this data, are encrypted with a cryptographic key. Encrypted formats are thus always opaque, since in this case, the content itself, but not its authenticity, shall be protected.

For symmetric encryption, e.g. a key can be derived from a password (password based encryption). In a symmetric encryption a random generated symmetric key can be used for encryption. This symmetric key is then encrypted with the asymmetric key and transferred together with the encrypted data into the format, on which the cryptographic protocol is based.

The known encoding components are mostly based on the use of personalized cryptographic keys by the respective person, and/or central devices. Widely used are in particular asymmetric encoding methods with a public and a private key each, whose authenticity is secured by a central certification authority (CA, certificate authority). Furthermore, also proprietary solutions are being used, which generate individually encoded or digitally signed containers from e-mail messages and deliver them to their recipient. At a communication partner, then a data environment must be available, which allows the decryption, or the verification of the e-mail messages or containers. WO 98/49643 thus suggests that a program is available to the sender of an e-mail message, which must also be available to the recipient in order to decode the e-mail message encoded by the program.

Though particular asymmetric encoding methods, e.g. according to S-MIME or open PGP, are supported by most commercially available e-mail programs, and are additionally required at an increasing extent for the electronic communication with government offices, they have not encountered any significant use in the business and private sector. Thus, their use, on the one hand, requires that the sender and also the recipient of an accordingly encoded e-mail message activate the use of the respective method explicitly. On the other hand, the necessary inquiry at the respective external certification locations, in particular in secure company networks, is only possible with restrictions.

The known methods and systems for the secure exchange of an e-mail message are either restricted to a certain number of users, due to the restricted availability of these encoding methods, or they offer the opportunity of a non-secure communication in the sense of a undesired fallback position.

In the broader context of the invention, while methods are known to send various types of documents in PDF format; for example, DE 10 2004 052 934 A1 which discloses the automatic transmission of an analysis data from a medical technology device in a signed PDF file; or US 2002/0178353 A1, which discloses the automatic generation of PDF invoices from a database, and US 2003/0055 952 A1 which discloses the automatic display of surveillance information in PDF files, and their respective automatic distribution as an e-mail attachment, it would however be desirable and advantageous to provide an improved method and system for the secure exchange of an e-mail massage to obviate prior art shortcomings.

### SUMMARY OF THE INVENTION

According to one aspect of the present invention the secure exchange of an e-mail message without previous synchronizing of sender and recipient with respect to the technology is facilitated.

According to another aspect of the present invention a method for the secure exchange of an e-mail message includes that the e-mail message is initially encoded and subsequently transmitted to a recipient, wherein the e-mail message is converted into an encoded document, and the document is transmitted to the recipient as an e-mail attachment.

Another aspect of the invention includes a system for the secure exchange of an e-mail message, wherein the e-mail message can be initially encoded by means of an encoding component of the system, and can subsequently be sent by means of the system, wherein the e-mail message can be converted into an encoded document by means of the encoding component, and said document can be transmitted by means of the system as an e-mail attachment.

The present invention resolves prior art problems by converting the e-mail message into an encoded document, and the document transmitted to the recipient as an e-mail attachment. The transmission of an e-mail attachment, no matter in which format, typically does not require a previous synchronizing between sender and recipient. The technical prerequisites for the initially purely technical exchange of the e-mail message are thus significantly reduced, compared to the known methods.

The method for decoding of the document, which has been transmitted as an e-mail attachment, can be synchronized independently from the method and process of the exchange of the e-mail message. For example, the sender can communicate a password to the recipient, which is used for encoding before or after the exchange of the e-mail message via telephone, or via facsimile.

The e-mail message, which is to be exchanged, is converted into a document with decoding function. For an unauthorized person, a direct access is then problematic during message exchange, since this person has no capability to directly access the information content of the e-mail message.

Preferably, the e-mail message is converted into a document in PDF format, or in Microsoft Office format in the context of a method according to the invention. The PDF format, though a proprietary format, is an open format, at least for the use in its basic functions, here in particular with respect to encoding, for which furthermore practically on any hardware and system platform, including mobile PDAs, a reader is available, which provides these basic functions. When converting an e-mail into a PDF document, therefore, with any recipient, only the form of the decoding of the document, e.g. through communicating the password, which has been used, has to be synchronized.

The Microsoft Office format as a quasi industry standard, like the PDF, is also widely used, and also comprises an encoding function, though this encoding function is comparatively basic. In comparison to the use of PDF, the Microsoft Office format, however, is hardly documented, and, on the other hand, was abused quite a few times in the past, in order to include malware, in particular viruses, in the form of scripts. E-mail attachments in Microsoft Office formats at e-mail messages from external senders are therefore often not allowed in company networks.

According to the invention, only standard formats are used, instead of not widely used, or cryptographic infrastructures, which are difficult to process, or proprietary components, which additionally still would have to support all major standards, wherein the display software of the standard formats already incorporates this functionality for deciphering or verification. This way, it is assured that the required decryption or verification component is available to a recipient, who can read the document.

When the converted document is transmitted as an e-mail attachment, it is possible to convert several attachments of the original message into an e-mail attachment.

In an advantageous embodiment of a method according to the invention, an executable program code is integrated into the document for answering the e-mail message. In particular the data formats mentioned above offer the capability to integrate such program code in the form of binary code, or as an executable script into the document. When such a program code allows an encoded reply to the e-mail message, a secure communication with the sender of the e-mail message is assured, without additional infrastructure on the side of the recipient.

Furthermore, a Meta information can be integrated into the document in the context of a method according to the invention. For example, information with regard to the sender of the e-mail message and also with regard to the time of sending can be integrated for documentation purposes in a file header, which is only visible by means of the reader through additional functions.

For example, an identification number can be integrated into the document in an advantageous manner, which clearly identifies the e-mail message. Such an identification number can e.g. coincide with a message identifier, generated by an e-mail program of the sender (according to RFC 2822) of the e-mail message. Such a unique identification number allows a unique reference to the received e-mail message in a reply in a simple manner.

In a particularly preferred embodiment, the document is encoded by means of a password in the context of a method according to the invention. Encoding by means of a password, particularly in the context of the above listed data formats, can be realized in a particularly simple manner from a technical point of view, and, on the other hand, facilitates the necessary synchronization between sender and recipient.

In the context of such a method according to the invention, the password can be integrated into the document, in particular for answering the e-mail message. When e.g. the password is integrated in the context of an executable program code for answering the e-mail message, the recipient of the e-mail message does not have to enter this password again for answering. Answering the e-mail message is thus substantially simplified.

Advantageously, a document produced according to a method according to the invention can be transmitted together with a certificate, for answering the e-mail message. For example, a public key of the sender can be integrated into the document, or can be transmitted to the recipient as another attachment to the message.

When the document includes a meta information portion, which is not visible as product specific, depending on the reader, the public certificate of the original sender can be included in the document through this portion, e.g. in case of asymmetric encoding, and can thus be used for encoding an answer to the e-mail message.

When the document comprises a unique identification number, it can e.g. be predetermined in advance by this ID number, which recipient may receive the message.

Furthermore, in the context of a method according to the invention, a reference to a website established for answering the e-mail is transmitted together with the document. In particular, in the context of company networks, but increasingly also in the private sector, publicly accessible websites are available to senders of e-mail messages on the internet for free configuration. Specifically such a website can be established dynamically, depending on an identification number of an e-mail message, for answering an e-mail message. When a reference (also link) to such a website is integrated into the document, or transmitted with the e-mail attachment in text format to the recipient of the e-mail, the recipient of the e-mail message does not necessarily have to allow the execution of executable code in the reader for answering said message. The secure answering of the e-mail message is thus also possible with higher safety requirements.

When a link is embedded in the document, which refers the recipient of the document to a website, belonging to the infrastructure of the sender for answering, it is traceable, which server has to be connected, which person has answered the e-mail, which original e-mail message is being answered, and with which password or certificate the document was encoded. The secured website then transfers the e-mail message, e.g. stored in the form of an e-mail message to the proper recipient without an entity connected in between, which then takes over the particular delivery.

In order to secure the transmission, the document can also be transferred encoded. In case of a symmetric encoding, the password can be transmitted encoded together with the document, and can thus be used for symmetric encoding of a secure answer by means of a document internal script implementation.

Alternatively, or additionally, in case of symmetric encoding, the certificate of the sender can be transmitted in the document. The answer can then be performed asymmetric or symmetric, if the standard format supports an asymmetric encoding. In case of a symmetric encoding, a separate infrastructure is not required on the side of the recipient.

Based on known systems, it is suggested according to the invention, that the e-mail message can be converted into an encoded document by means of the encoding component, and that this encoded document can be transmitted by the system as an e-mail attachment. Such a system according to the invention allows the execution of a method according to the invention as described above.

In an advantageous manner, a method according to the invention comprises an address register, by means of which the encoding component can be configured sender and/or recipient specific, in order to provide the entire infrastructure more secure. A configuration component of the system according to the invention then e.g. accesses the address register in order to provide a password of the encoding component again, which has already been agreed upon for the communication with a recipient of an e-mail message.

Based on such an address register, a policy can be defined, which is generally agreed upon in the company of the sender, which determines an encoding method, e.g. individually, for particular recipient addresses, or also for recipient addresses of a specified domain. Alternatively, the encoding can be also defined by the sender by means of control sequences in the “subject” field, or in case of automatically sent e-mail messages in an X-header of the e-mail message.

### DETAILED DESCRIPTION OF PREFERRED EMBODIMENTS

Other features and advantages of the present invention will be more readily apparent upon reading the following description of a currently preferred exemplified embodiment of the invention with reference to the accompanying drawing, in which the drawing FIGURE illustrates the exchange of an e-mail message 1 between a sender 2 in a company network, which is not shown in more detail, and a recipient 3 outside of this company network.

The sender 2 writes an e-mail message 1 in a common e-mail client on his workstation 4, and adds the remark “{crypt_pdf 4711}” at the beginning of the subject line, and sends the e-mail message 1 to the recipient 3.

In the company network, incoming and outgoing e-mail messages are managed by a system 5 according to the invention, operating as a “mail server”. A processing component of the system 5, which is not illustrated in more detail, interprets the remark in the subject line based on the “{}” as a control sequence, and based on the keyword “cryp_pdf” as a command of the sender 2, in order to code the e-mail message 1 with the character sequence “4711” as a key 6.

The processing component initially extracts the text content from the body of the e-mail message 1 and writes it into a document 7 in PDF format. An S-MIME certificate of the sender 2 attached to the e-mail message 1 and a CAD drawing, also attached to the e-mail message 1 add the processing component to the document 7 as an attachment. Furthermore, the processing component adds a company specific welcome page and, behind the text content, a particular answering page to the document 7 before the particular text content. Subsequently, the processing component encodes the document 7 with the key 6 and attaches it as an e-mail attachment 8 to a second non-encoded e-mail message 9.

The second e-mail message 9 provides the processing component with the addresses of sender 2 and recipient 3, which are also extracted from the first e-mail message 1, adds a standard remark in its body, according to which the attachment includes an automatically encoded message of the sender 2, and sends the second e-mail message 9 through the internet to the external recipient 3. Furthermore, the processing component arranges by means of a validation and configuration component of the system 5, that the key 6 for the recipient 3 is stored in an address register 10 for a possible later use.

In the meantime, the sender 2 has telephonically announced the e-mail message 1 to the recipient 3 via his mobile phone 11, and communicated the key 6 to him. The recipient 3 receives the second e-mail message 9 in an e-mail client of his PDA 12, confirms opening the e-mail attachment 8 in the PDF reader of his PDA 12, enters the key 6 through its keyboard in response to the respective request of the PDF reader, and reads the e-mail message 1 in the decrypted document 7. For answering the e-mail message 1, the recipient 3 selects the reference listed in the attached page of the document 7 with this regard to the website personalized for this e-mail message 1 on the system 5 according to the invention, and writes a reply to the sender 2 of the e-mail message 1 in the webmail interface of this website.

The website initially sends the reply in the company network directly as another e-mail message (not shown) to the sender 2. In order to furthermore document the reply for the recipient 3, the website furthermore transfers said reply to the processing component, which requests the key 6 from the address register 10 for the recipient 3, converts the reply into another encoded document, as described above, and transfers it in return as an e-mail attachment 8 to the recipient 3.

Accordingly, various different transmission paths for the secure exchange of e-mail messages can be displayed.

When an e-mail message 1 is transmitted from the sender 2 to the processing component, said processing component determines based on the configuration component, if the e-mail message 1 is to be processed or not. For this purpose, the configuration component accesses an address register in order to verify a sender/recipient. Subsequently, a decision is made, how to proceed with the e-mail message 1: when the e-mail message 1 is to be sent, the e-mail message 1 is transferred into a document 7, which provides a possibility to answer the e-mail message 1 in a secure manner. The answer can be performed by means of a document internal script implementation, or by means of a document specific link, identifying the e-mail message 1 to a secure website. If the e-mail message 1 includes attachments, these are integrated as attachments into the generated document 7, or separately transferred into a respective document format. When the attachments of the e-mail message 1 are already available in standard format, this step can be omitted, and the coding can be directly initiated for these attachments. The documents to be sent are then being encoded, (encrypted, signed, encrypted and signed, or provided with another form of document specific rights) and transmitted to the recipient 3 as an e-mail attachment 8.

When an e-mail from an external communication partner is received, the processing component determines if this is a regular e-mail message, or an e-mail message, which constitutes a secure reply to an e-mail message 1, previously processed by a processing component. If the incoming e-mail message is a secure reply to a document 7, previously generated from an e-mail message 1, the processing component transposes said e-mail message into a normal e-mail message, which is processed further, according to the typical security methods for e-mail messages. Further documents attached to the incoming e-mail message can be provided with another form of document specific rights. A secure reply can be performed by calling up a secure web page by means of a link provided by the document 7. Alternatively, the reply is performed directly from the document 7, for which purpose the document 7 provides the necessary mechanisms. The reply is either encoded directly from the document 7 (encrypted, signed, encrypted and signed, or provided with another form of document specific rights), sent to the recipient 3 or an encoded document 7 is generated, which is sent as a mail attachment 8. By means of a link provided by the document 7, the recipient 3 is directed to a secure website, where he can directly write a reply in case an authentication is required. Herein, the context of the e-mail message 1 is maintained (message history).

Typically, the e-mail message 1 scheduled for sending is converted into a document 7, comprising a standard format with decryption function. The encoded document 7 can be created in the form of a composite document, e.g. the document 7 itself includes the particular text of the e-mail message 1 and a document attachment includes all attachments of the e-mail message 1. As a result, a single encoded document 7 is sent as an e-mail attachment of a second e-mail message 9.

While the invention has been illustrated and described as embodied in a method and system for the secure exchange of an e-mail, it is not intended to be limited to the details shown since various modifications and structural changes may be made without departing in any way from the spirit of the present invention. The embodiment was chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for the secure exchange of an e-mail message, wherein the e-mail message is initially encoded and subsequently transmitted to a recipient, wherein the e-mail message is converted into an encoded document, and the document is transmitted to the recipient as an e-mail attachment.

2. The method according to claim 1, wherein the e-mail message is converted into a document in PDF format, or in Microsoft Office format.

3. The method according to claim 1, wherein an executable program code is integrated into the document for answering the e-mail message.

4. The method according to claim 1, wherein a Meta information is integrated into the document.

5. The method according to claim 4, wherein an identification number is integrated into the document.

6. The method according to claim 1, wherein the document is encoded with a password.

7. The method according to claim 6, wherein the password is integrated into the document for answering the e-mail message.

8. The method according to claim 3, wherein for replying to the e-mail message a certificate is transmitted together with the document.

9. The method according to claim 3, wherein a link to a website configured for replying to the e-mail message is transmitted with the document.

10. A system for the secure exchange of an e-mail message, wherein the e-mail message can be initially encoded by means of an encoding component of the system, and can subsequently be sent by means of the system, wherein the e-mail message can be converted into an encoded document by means of the encoding component, and said document can be transmitted by means of the system as an e-mail attachment.

11. The system according to claim 10, characterized by an address register, by means of which the encoding component can be configured sender- and/or recipient specific.

12. The system according to claim 10, characterized by a website, by means of which an e-mail message, transmitted by the system to a recipient, can be answered by the recipient.
